(19) United States
(12) Patent Application Publication
(10) Pub. No.: US 2011/0197847 A1
(43) Pub. Date: Aug. 18, 2011

(54) CONNECTING ROD-PISTON GROUP

(76) Inventor: Evgeny Nikolaevich Zakharov, Moscovskaya oblast (RU)

(21) Appl. No.: 12/998,368

(22) PCT Filed: Oct. 13, 2009
(86) PCT No.: PCT/RU2009/000537

§ 371 Date: Apr. 13, 2011

(30) Foreign Application Priority Data
Oct. 14, 2008 (RU) 2008140442

(51) Int. Cl. F02B 75/32

(52) U.S. Cl. 123/197.2

(57) ABSTRACT

The invention relates to mechanical engineering, in particular to units for piston machines, primarily internal combustion engines. A connecting rod and piston assembly comprises a piston, which is accommodated in a cylinder and is provided with a head and an insert, a piston pin, and a connecting rod with top and bottom heads and a bar. The insert is in the form of a hollow, box-like stiffening rib that transmits reactive load from the connecting rod to a housing via contact surfaces. The top head and a part of the connecting rod bar are accommodated in the box cavity, and a hole for the piston pin is provided in the side walls of the insert box. The head is connected to the insert with the aid of a hinged joint so that the head can self-center along the cylinder surface by moving in all directions with respect to the insert on a plane that intersects the longitudinal axis of the cylinder. The housing is provided with mating contact surfaces which interact with the contact surfaces of the insert and which are located on separate supporting elements secured on the housing. The technical result consists in increasing the performance, reliability and service life of machines which use the described assembly and in achieving high specific mass and dimensional parameters of such machines.

### FIELD OF THE INVENTION

The invention relates to the sphere of machine building, in particular to assemblies of piston machines, and mainly to internal combustion engines.

### BACKGROUND ART

As is known there exists a connecting rod-piston group comprising a piston installed inside a cylinder with a crown and an insert, a piston pin and a connecting rod with an upper head (small end) and a lower head (big end), and a body (Ref. USSR Authorship Certificate No. 220675, published on Jun. 28, 1968).

The disadvantages of the known connecting rod-piston group are its low performance coefficient, reliability and short life due to incapability of the piston crown to self-align along the cylinder surface in all directions and due to deformation of the cylinder surface and its overheating caused by friction occurring when the reactive load of the connecting rod is transferred to the housing.

### SUMMARY OF THE INVENTION

The technical result consists in the increased performance coefficient, improved reliability, extended life and decreased specific weight and size parameters of the machines utilizing the described assembly.

The claimed objective is achieved by the fact that in the connecting rod-piston group comprising a piston with at least a crown and an insert, a piston pin and a connecting rod with a small end, a big end, and a body, where the piston is installed inside a cylinder secured to the engine housing, and the insert is made as a hollow box-like stiffener transferring the reactive load from the connecting rod to the housing through contact surfaces, the box cavity accommodates the small end and some part of the connecting rod body, the hole for the piston pin is made in the side walls of the insert box, the crown is coupled with the insert by means of a hinge enabling it to self-align along the cylinder surface due to its travel relative to the insert in all directions, at least in the plane crossing the cylinder longitudinal axis, where the housing is provided with mating contact surfaces interacting with the insert contact surfaces, these mating contact surfaces located on separate support elements secured to the housing.

The claimed objective is also achieved by the fact that the space between the contact surfaces of the housing and insert may accommodate rollers equipped with synchronizing pinions, while each contact surface may be provided with toothed racks engaged with the respective synchronizing pinions of the rollers.

The claimed objective is also achieved by the fact that support elements may be provided with a mechanism to adjust their spatial position.

The claimed objective is also achieved by the fact that the pin may be made as a central cylindrical body, its end surfaces bearing projections in the form of segments, which cylindrical outer surface is a continuation of the central cylindrical body, while the outer surface of the central cylindrical body middle part interacts with the connecting rod small end by means of rolling elements, its extreme cylindrical surfaces contact with the inner surface of the holes in the insert box side walls, and the cylindrical surfaces of the segment-shaped projections contact with the surface of the insert, which transfers the force through the pin to the connecting rod.

The claimed objective is also achieved by the fact that the piston may be provided with a skirt.

The claimed objective is also achieved by the fact that the skirt may be made as a sleeve with a bead arranged around the insert, or the skirt may be made as a single piece with the crown in the form of a sleeve arranged around the insert.

### BRIEF DESCRIPTION OF THE DRAWINGS

FIG. 1 shows a two-stroke engine with the described connecting rod-piston group, with its piston in the bottom dead center (BDC).

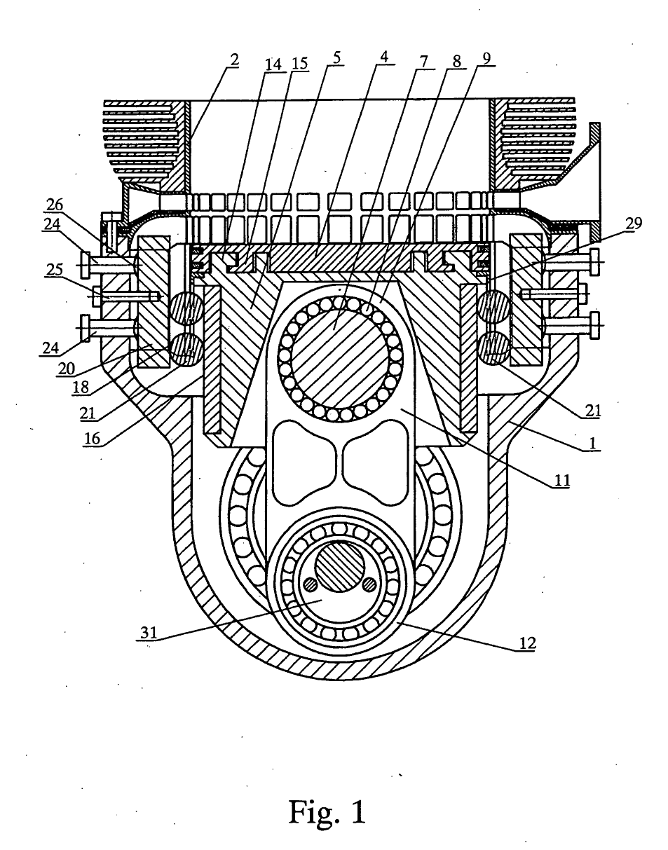

FIG. 2 shows the same, with its piston in the top dead center (TDC).

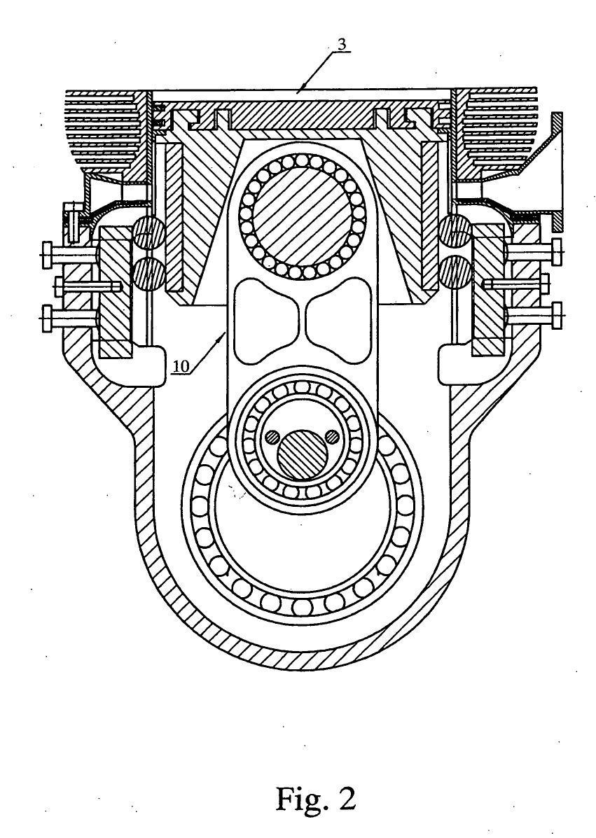

FIG. 3 shows a 3D view of the connecting rod-piston group assembly.

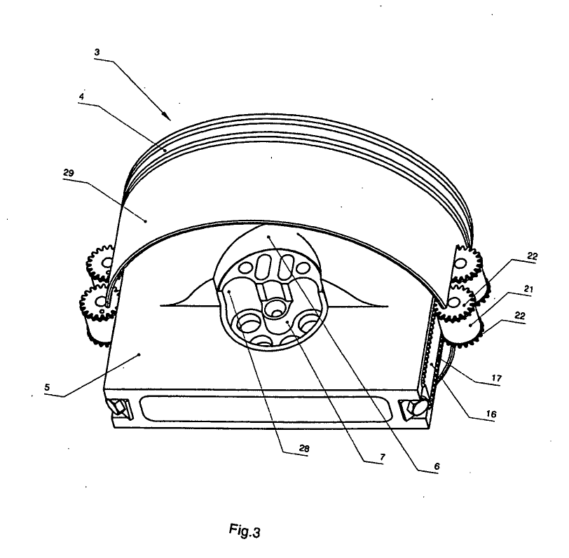

FIG. 4 shows the same, with designation of components.

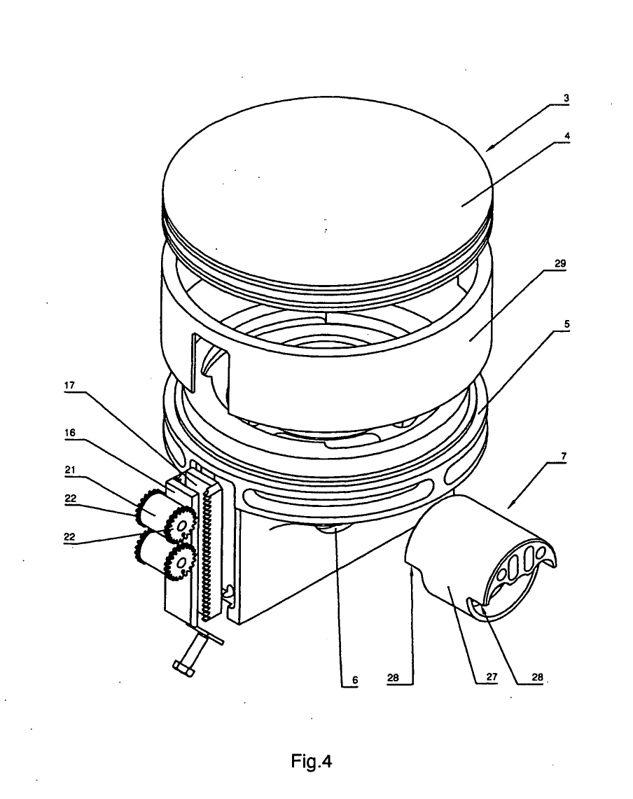

FIG. 5 shows the piston pin.

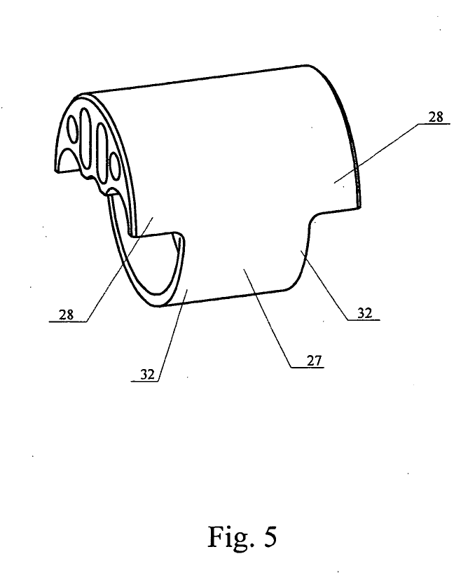

### THE BEST EMBODIMENT OF THE INVENTION

The engine with the described connecting rod-piston group comprises housing 1, cylinder 2 secured thereto and incorporating piston 3, which is provided with crown 4 and insert 5 made as a hollow box-like stiffener. Fitted into holes 6 of insert 5 is piston pin 7 interacting by means of rolling elements 8 with small end 9 of connecting rod 10 incorporating body 11 and big end 12. Crown 4 of piston 3 is coupled with insert 5 by means of hinge 13 made, for example, as a bayonet connection with a radial clearance between annular projections 14 and 15 on crown 4 and insert 5, respectively. The radial clearance enables crown 5 to travel relative to insert 5 in all directions in the transverse plane only, while limiting their relative travel along piston 3 reciprocation.

Insert 5 is provided with contact surfaces 16 with toothed racks 17, while mating contact surfaces 18 are provided with toothed racks 19 and mounted on separate support elements 20 secured to housing 1. Mounted between contact surfaces 16 and 18 are rollers 21 with synchronizing pinions 22 engaged with racks 17 and 19. Direct contact between surfaces 16 and 18 is also possible, with their relative sliding during piston 3 reciprocation.

Support elements 20 are provided with mechanism 23 to adjust their spatial position. Mechanism 23 contains threaded elements (bolts) 24, which end surfaces contact with support elements 20 and force them away from housing 1 while thrusting contact surfaces 18 against rollers 21 and contact surfaces 16 of insert 5. To prevent support elements 20 from falling into the space of housing 1 during the machine assembly and to provide a reliable contact with the support end surfaces of bolts 24 in the course of its operation, support elements 20 are drawn towards housing 1 to bolts 24 by means of threaded connection 25. To relieve stresses in threaded connections and in the place where bolts 24 contact with support elements 25, thrust blocks 26 with spherical surfaces are fitted between the end face of bolts 24 and support elements 20.

Piston pin 7 may be made as a central cylindrical body 27, its end surfaces mounting projections 28 in the form of segments, which cylindrical surface is a continuation of central cylindrical body 27. The outer surface of the middle part of central cylindrical body 27 interacts with connecting rod small end 9 by means of rolling elements 8. Extreme cylindrical surfaces 32 of central cylindrical body 27 contact with the inner surface of holes 6 in the side walls of insert 5 box. The cylindrical surfaces of segment-shaped projections 28 contact with the surface of insert 5, which transfers the force through pin 7 to connecting rod 10.

In addition to crown 4 and insert 5, piston 3 may comprise skirt 29 made as sleeve with bead 30. Or skirt 29 may be made as a single piece with crown 4. Since skirt 29 does not participate in reactive load transfer within the scope of the described invention, it may be made thin-walled and may serve as an extension of the guiding surface of crown 4 to increase its self-alignment reliability. In two-stroke engines with slot-type scavenging, skirt 29 may perform the function of a slide valve for shutting off the exhaust ports, when piston 3 is near TDC.

The piston machine with the described connecting rod-piston group operates as follows.

Reciprocations of piston 3 are converted by means of connecting rod 10 and crank 31 into rotation of the crankshaft or, vice versa, rotation of shaft 32 is converted into reciprocation of piston 3. In any mechanism where conversion of motion takes place, a reactive force arises during its operation, which is taken up by the housing. In the piston machine the reactive force is usually taken up by the operating surface of the cylinder directly from the piston body. Such direct contact results in deformations both in the cylinder surface and piston body, which deteriorates the work space sealing reliability and leads to a fast wear of contact surfaces due to their overheating because of both gas blow-by and friction.

Besides, overheating of contacting parts and employment of sliding friction implies presence of a guaranteed clearance in the interface, which results in angular oscillations of the whole piston together with the crown and rings. This also leads to a decreased work space sealing reliability. Thereat, to provide sliding, a guaranteed layer of liquid lubricant is required on all motion areas and in all modes, which is a general problem of all reciprocating couples. As for the internal combustion engine, there appears an additional problem of retaining lubricant on the cylinder overheated surface.

Arrangement of contact surfaces 18 outside of cylinder 2 makes it possible to relieve it from being exposed to reactive forces. Absence of lateral loads acting on the surface of cylinder 2, provision for its uniform heating along the circumference, and self-alignment of crown 4 of piston 3 with sealing rings make it possible to improve the work space sealing reliability along the whole operating stroke of piston 3.

Employment of rollers 21 rolling in a reciprocating manner between contact surfaces 18 and 16 provides for a substantial reduction of mechanical losses. At the same time, angular oscillations of piston 3, inaccuracy of its installation and relative deformations (thermal and mechanical) of the housing and cylinder do not affect the position of its crown 4 due to presence of hinge 13.

In the two-stroke engine, piston pin 7 is exposed to a one-direction load. Therefore, on the side of this load action (on the side of the combustion chamber), the surface of pin 7 is made a large as possible with an acceptable stiffness provided, while on the side of shaft 32 the surface is made minimal and intended just for transferring the force action to connecting rod 10 and for retaining pin 7 in insert 5. No break-away inertial forces occur in two-stroke engines, therefore thickness of insert 5 box-like stiffener walls may be relatively low, which provides an advantage from the viewpoint of the engine configuration and makes it possible to decrease its dimensions along the cylinder axis. With the shape of pin 7 optimized in such a manner, its weight is decreased as well.

### INDUSTRIAL APPLICABILITY

Thus, employment of the described connecting rod-piston group makes it possible to increase the performance coefficient of piston machines by both decreasing direct mechanical losses and improving the operating conditions for the cylinder-piston couple, to improve reliability and extend life of machines, and to decrease their specific weight and size parameters.

1. A connecting rod-piston group comprising a piston with at least a crown and an insert, a piston pin and a connecting rod with a small end, a big end, and a body, where the piston is installed inside a cylinder secured to the engine housing, and the insert is made as a hollow box-like stiffener transferring the reactive load from the connecting rod to the housing through contact surfaces, where the box cavity accommodates the small end and some part of the connecting rod body, the hole for the piston pin is made in the side walls of the insert box, the crown is coupled with the insert by means of a hinge enabling it to self-align along the cylinder surface due to its travel relative to the insert in all directions, at least in the plane crossing the cylinder longitudinal axis, where the housing is provided with mating contact surfaces interacting with the insert contact surfaces, these mating contact surfaces located on separate support elements secured to the housing.

2. A connecting rod-piston group of claim 1, wherein the space between the contact surfaces of the housing and insert accommodate rollers equipped with synchronizing pinions, while each contact surface is provided with toothed racks engaged with the respective synchronizing pinions of the rollers.

3. A connecting rod-piston group of claim 1, wherein the support elements are provided with a mechanism to adjust their spatial position.

4. A connecting rod-piston group of claim 1, wherein the pin is made as a central cylindrical body, its end surfaces bearing projections in the form of segments, which cylindrical outer surface is a continuation of the central cylindrical body, while the outer surface of the central cylindrical body middle part interacts with the connecting rod small end by means of rolling elements, its extreme cylindrical surfaces contact with the inner surface of the holes in the insert box side walls, and the cylindrical surfaces of the segment-shaped projections contact with the surface of the insert, which transfers the force through the pin to the connecting rod.

5. A connecting rod-piston group of claim 1, wherein the piston is provided with a skirt.

6. A connecting rod-piston group of claim 5, wherein the skirt is made as a sleeve with a bead arranged around the insert.

7. A connecting rod-piston group of claim 5, wherein the skirt is made as a single piece with the crown in the form of a sleeve arranged around the insert.
